(19) United States
(12) Patent Application Publication
(10) Pub. No.: US 2021/0081308 A1
(43) Pub. Date: Mar. 18, 2021

(54) GENERATING AUTOMATED TESTS BASED ON USER INTERACTION WITH AN APPLICATION

(71) Applicant: TestRigor, Inc., San Francisco, CA (US)

(72) Inventor: Artem Golubev, San Francisco, CA (US)

(21) Appl. No.: 17/017,279

(22) Filed: Sep. 10, 2020

Related U.S. Application Data
(60) Provisional application No. 62/900,161, filed on Sep. 13, 2019.

(51) Int. Cl. G06F 11/36

(52) U.S. Cl. CPC G06F 11/3688; G06F 11/3664; G06F 11/3684

(57) ABSTRACT

A technique is introduced for generating automated tests based on analysis of end user interactions with an application that is to be tested. In an example embodiment, the introduced technique includes monitoring end user interaction with an application in a production environment to generate user interaction data. This user interaction data can then be analyzed to generate automated tests that are specifically tailored to the application. In some embodiments, the automated test can be executed in a separate testing environment to produce results such as screen captures of user interaction flows as well as detect bugs, errors, or other issues.

### CROSS-REFERENCE TO RELATED APPLICATIONS

This application claims the benefit of U.S. Provisional Application No. 62/900,161 titled, “GENERATING AUTOMATED TESTS BASED ON USER INTERACTION WITH AN APPLICATION,” filed on Sep. 13, 2019, the contents of which are hereby incorporated by reference in their entirety for all purposes. This application is therefore entitled to a priority date of Sep. 13, 2019.

### BACKGROUND

Newly developed software applications typically require extensive testing to eliminate bugs and other errors before deployment for access by end users. In practice, the testing of user interfaces associated with applications can be particularly challenging. Several approaches have been implemented to test the user interface functionality of applications. A traditional approach involves the use of human quality assurance (QA) testers to manually interact with an application to identify bugs and other errors. Manual QA testing can be expensive and time consuming and can lead to inconsistent results since human testers are prone to mistakes. To address some shortcomings of manual testing, several tools (e.g., Selenium™, Appium™, and Calabash™) have been developed to automate the process. While existing automation tools can alleviate the need for extensive manual testing, such tools can present new issues. For example, existing automated testing tools require continued support to ensure that the automated tests still work within a framework of an application being tested. For example, if the framework of an application changes (e.g., in an updated version), a program for performing an automated test of the application will itself need to be updated. Further, both manual testing and existing automation tools typically provide poor testing coverage since they are limited by existing knowledge of the functionality of the application. Human QA testers will usually only cover what is described in a defined test case. Similarly, existing automation tools will only cover what is defined in their automation scripts.

### BRIEF DESCRIPTION OF THE DRAWINGS

FIG. 1 is a block diagram illustrating an example networked computing environment in which certain embodiments of the introduced technique can be implemented;

FIG. 2 is a block diagram illustrating another example computing environment in which the introduced technique can be implemented;

FIG. 3 is a block diagram illustrating a high-level architecture of an example automated testing platform;

FIG. 4 is an architecture flow diagram illustrating an example automated testing process;

FIG. 5 is an architecture flow diagram that illustrates an example process for recording user interaction with a target application;

FIG. 6 is an architecture flow diagram illustrating an example process for generating and executing automated tests based on recorded user interaction data;

FIG. 7 is a flow diagram illustrating an example process for analyzing user interaction data;

FIG. 8 is a flow diagram of an example process for generating and performing automated tests of a target application based on recorded user interaction with the target application; and

FIGS. 9-19 show a series of screens associated with an example graphical user interface (GUI) associated with an automated testing platform.

### DETAILED DESCRIPTION

### Overview

Automated application testing has several benefits over more traditional manual approaches. However, existing automation tools are only as good as the test cases they are programmed for. This leads to insufficient test coverage and wasteful spending of time and computing resources testing unimportant functionality of an application. To address these challenges and the limitations of exiting tools, a technique is introduced for generating automated tests based on analysis of end user interactions with an application that is to be tested. In an example embodiment, the introduced technique includes monitoring end user interaction with an application in a production environment to generate user interaction data. This user interaction data can then be analyzed to generate automated tests that are specifically tailored to the application. Further, certain testing scenarios can be prioritized based on monitored user interaction with the application to ensure that the most important and extensively utilized functionalities of the application are tested over other less important functionalities. Specifically tailoring automated tests based on monitored user interaction with an application can therefore lead to quicker execution and lower computational resource requirements.

### Automated Testing Platform

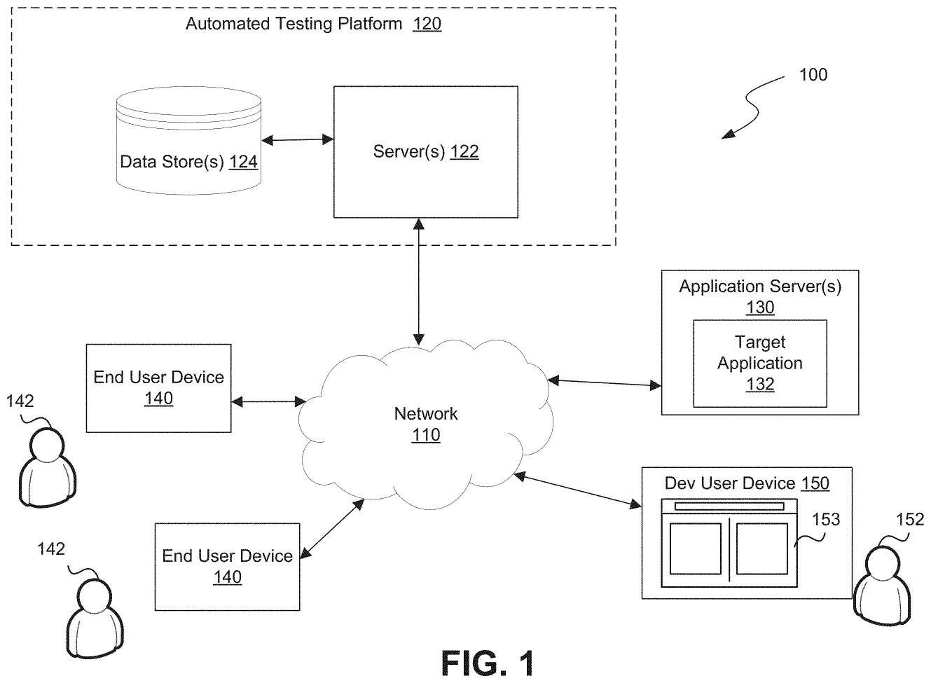

FIG. 1 is a block diagram illustrating an embodiment of a networked computing environment 100 in which certain embodiments of the introduced technique can be implemented. As shown in FIG. 1, the example networked computing environment 100 includes an automated testing platform 120 for performing automated testing of a target application 132, according to the introduced technique.

The example networked computing environment 100 depicted in FIG. 1 includes a network 110 over which various network-connected computing devices and systems are capable of communicating. Network 110 can include a single distinct network or can include a collection of distinct networks operating wholly or partially in conjunction to provide connectivity between network-connected computing systems. For example, network 110 may include one or more of a wired or wireless local area network (LAN), a wired or wireless wide area network (WAN), a cellular data network, or any other appropriate communication network. Further, the one or more networks can include open networks (e.g., the Internet) and/or private networks (e.g., an intranet and/or an extranet). Communication between network-connected computing systems over network 110 may be over any known communication protocol or model such as the Internet Protocol Suite (i.e., TCP/IP), the Open System Interconnections (OSI) model, the User Datagram Protocol (UDP), the File Transfer Protocol (FTP), etc.

The automated testing platform 120 may include one or more server computer systems 122 with processing capabilities for performing embodiments of the introduced technique. The automated testing platform 120 may also include non-transitory processor-readable storage media or other data storage facilities for storing instructions that are executed by a processor and/or storing other data utilized when performing embodiments of the introduced technique. For example, the automated testing platform 120 may include one or more data store(s) 124 for storing data. Data store 124 may represent any type of machine-readable capable of storing structure and/or unstructured data. Data stored at data store 124 may include, for example, image data (e.g., screen captures), video data, audio data, machine learning models, testing scenario data, recorded user interaction data, testing files (e.g., copies of a target application), etc. Note that the term “data store” is used for illustrative simplicity to refer to data storage facilities, but shall be understood to include any one or more of a database, a data warehouse, a data lake, a data mart, data repository, etc.

While illustrated in FIG. 1 as a single server computer system 122 and associated data store 124, many implementations may employ two or more server computer systems 122 and/or data stores 124. Further, the server computer systems 122 depicted in FIG. 1 may represent physical computing devices and/or virtualized devices instantiated at one or more physical computing devices at a single physical location or distributed at multiple physical locations. Similarly, data store 124 may represent multiple data stores, each of which may be distributed across multiple physical computing devices.

In some embodiments, certain components of automated testing platform 120 may be hosted or otherwise provided by separate cloud computing providers such as Amazon Web Services (AWS)™ or Microsoft Azure™. For example, AWS™ provides cloud-based computing capabilities (e.g., EC2 virtual servers), cloud-based data storage (e.g., S3 storage buckets), cloud-based database management (e.g., DynamoDB™), cloud-based machine-learning services (e.g., SageMaker™), and various other services. Other cloud computing providers provide similar services and/or other cloud-computing services not listed. In some embodiments, the components of automated testing platform 120 may include a combination of components managed and operated by a provider of the automated testing platform 120 (e.g., an internal physical server computer) as well as other components managed and operated by a separate cloud computing provider such as AWS™.

The automated testing platform 120 can be implemented to perform automated testing of a target application 132. The target application 132 may include any type of application (or app) configured to run on personal computers (e.g., for Windows™, MacOS™, etc.), applications configured to run on mobile devices (e.g., for Apple™ iOS, Android™, etc.), web applications, websites, etc. In some embodiments, the automated testing platform 120 is configured to perform automated testing of various GUI functionality associated with a target application 132. For example, in the case of a website with interactive elements, automated testing platform 120 may be configured to test the interactive elements associated with the website as presented via one or more different web browser applications.

The target application 132 can be hosted by a networked computer system connected to network 110 such as an application server 130. In the case of a website, application server 130 may be referred to as a web server. In any case, as with server 122, application server 130 may represent a single physical computing device or may represent multiple physical and/or virtual computing devices at a single physical location or distributed at multiple physical locations.

Various end users 142 can access the functionality of the target application 132, for example, by communicating with applications server 130 over network 110 using a network-connected end user device 140. An end user device 140 may represent a desktop computer, a laptop computer, a server computer, a smartphone (e.g., Apple iPhone™), a tablet computer (e.g., Apple iPad™), a wearable device (e.g., Apple Watch™), an augmented reality (AR) device (e.g. Microsoft Hololens™), a virtual reality (VR) device (e.g., Oculus Rift™), an internet-of-things (IOT) device, or any other type of computing device capable of applying the functionality of target application 132. In some embodiments, end users 142 may interact with the target application via a GUI presented at the end user device 140. In some embodiments, the GUI through which the user 142 interacts with the target application 132 may be associated with the target application 132 itself or may be associated with a related application such as a web browser in the case of a website. In some embodiments, interaction by the end user 142 with the target application 132 may include downloading the target application 132 (or certain portions thereof) to the end user device 140.

A developer user 152 associated with the target application 132 (e.g., a developer of the target application 132) can utilize the functionality provided by automated testing platform 120 to perform automated testing of the target application 132 during development and/or after the target application has entered production. To do so, developer user 152 can utilize interface 153 presented at a developer user device 150, for example, to configure an automated test, initiate the automated test, and view results of the automated test. Interface 153 may include a GUI configured to receive user inputs and present visual outputs. The interface 153 may be accessible via a web browser, desktop application, mobile application, or over-the-top (OTT) application, or any other type of application at developer user device 150. Similar to end user devices 140, developer user device 150 may represent a desktop computer, a laptop computer, a server computer, a smartphone, a tablet computer, a wearable device, an AR device, a VR device, or any other type of computing device capable of presenting interface 153, and/or communicating over network 110.

Although the networked computing environment 100 depicted in FIG. 1 shows only one developer user 152 and one target application 132 for testing, in some embodiments, multiple different developer users associated with multiple different target applications may access the automated testing functionality of automated testing platform 120. For example, the various functionalities associated with automated testing platform 120 may be provided to various application developers as a service to test their respective applications during development and/or after entering production. In some embodiments, automated testing services may be provided by the automated testing platform 120 for a one-time and/or subscription fee. Developer users signing up for the automated testing services may access such services by connecting, for example, via network 110 to the automated testing platform 120. In other words, in some embodiments, automated testing services can be provided to the developer users without downloading or installing any software to a computing system associated with or managed by the respective developer users.

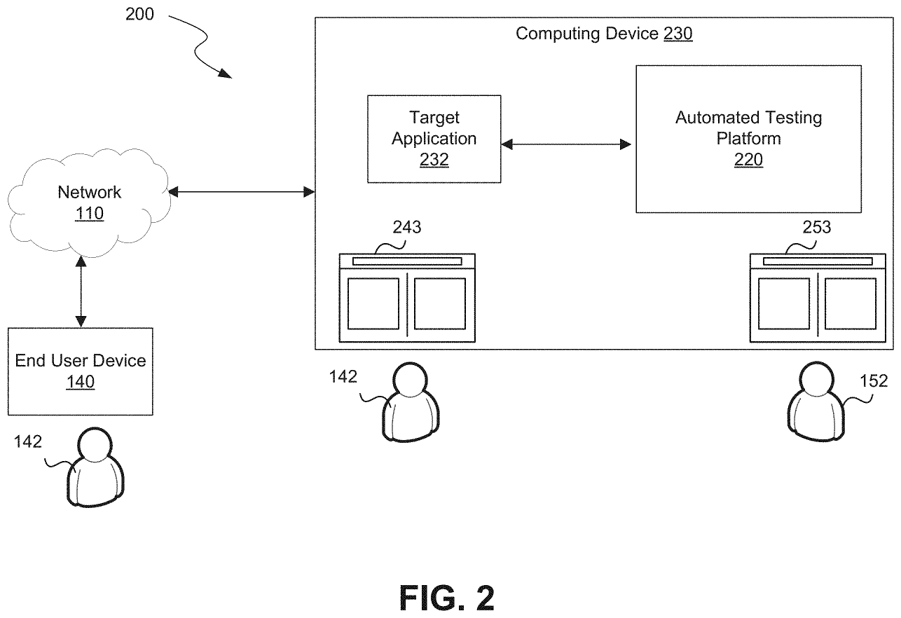

FIG. 1 depicts an automated testing platform 120 in the context of a networked computing environment 100; however, the introduced technique is not limited to such a context. In some embodiments, one or more components of automated testing platform 120 may be instantiated locally at a computing device that hosts the target application. For example, FIG. 2 depicts an alternative computing environment 200 in which the introduced technique can be implemented. As shown in FIG. 2, a computing device 230 hosts both the target application 232 (analogous to target application 132) as well as the automated testing platform 220. In this example, automated testing platform 220 may represent software installed at computing device 220. In other words, target application and automated testing platform 220 may share the common computing hardware (e.g., memory, processor, storage, etc.) of computing device 230 although they may be implemented in different virtual machines instantiated at computing device 230. End users 142 may access the functionally of target application 232 locally, for example, via interface 243 and/or remotely via network 110 using a network-connected end user device 140. Further, the developer user 152 may interact with the automated testing platform 220 via interface 253 (analogous to interface 153), for example, to configure an automated test, initiate the automated test, and view results of the automated test.

One or more of the devices and systems described with respect to FIGS. 1-2 (e.g., automated testing platform 120, application server 130, end user devices 140, developer user device 150, computing device 230, etc.) may be implemented as computer processing systems. As used herein, a “computer processing system” may include one or more processors (e.g., central processing units (CPU), graphical processing units (GPU), etc.) that are coupled to one or more memory (e.g., volatile and/or non-volatile) that store instructions that can be executed using the one or more processors to perform operations associated with the introduced technique. A computer processing system may further include one or more storage media such as hard disk drives (HDD), solid state drives (SSD), and/or removable storage media (e.g., Compact Disc Read-Only Memory (CD-ROM)). The memory and storage media may be collectively referred to herein as non-transitory computer-readable (or machine-readable) media. Such non-transitory computer-readable media may include single devices or may include system of multiple devices at different physical locations (e.g., distributed databases).

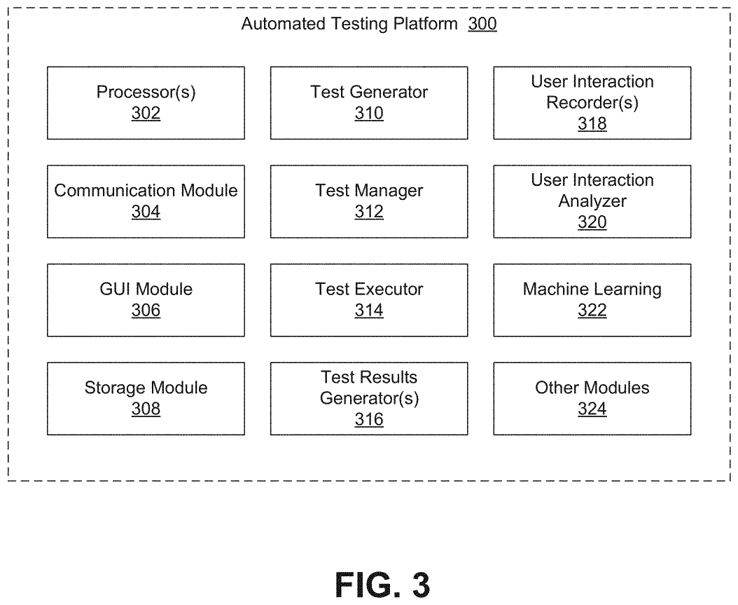

FIG. 3 is a block diagram illustrating a high-level architecture of an example automated testing platform 300. Example automated testing platform 300 may be the same or similar to automated testing platform 120 depicted in FIG. 1 and automated testing platform 220 depicted in FIG. 2. As shown in FIG. 3, automated testing platform 300 includes one or more processors 302, a communication module 304, a GUI module 306, a storage module 308, a test generator module 310, a test manager module 312, a test executor module 314, a test results generator module 316, a user interaction recorder module 318, a user interaction analyzer module 320, a machine learning module 322, and may include other modules 324.

Each of the modules of example automated testing platform 300 may be implemented in software, hardware, or any combination thereof. In some embodiments, a single storage module 308 includes multiple computer programs for performing different operations (e.g., metadata extraction, image processing, digital feature analysis), while in other embodiments, each computer program is hosted within a separate storage module. Embodiments of the automated testing platform 300 may include some or all of these components, as well as other components not shown here.

The processor(s) 302 can execute modules from instructions stored in the storage module(s) 308, which can be any device or mechanism capable of storing information. For example, the processor(s) 302 may execute the GUI module 306, a test generator module 310, a test manager module 312, a test executor module 314, etc.

The communication module 304 can manage communications between various components of the automated testing platform 300. The communication module 304 can also manage communications between a computing device on which the automated testing platform 300 (or a portion thereof) resides and another computing device.

For example, the automated testing platform 300 may reside one or more network-connected server devices. In such embodiments, the communication module 304 can facilitate communication between the one or more network-connected server devices associated with the platform as well as communications with other computing devices such as an application server 130 that hosts the target application 132. The communication module 304 may facilitate communication with various system components through the use of one or more application programming interfaces (APIs).

The GUI module 306 can generate the interface(s) through which an individual (e.g., a developer user 152) can interact with the automated testing platform 300. For example, GUI module 306 may cause display of an interface 153 at computing device 150 associated with the developer user 152.

The storage module 308 may include various facilities for storing data such as data store 124 as well as memory for storing the instructions for executing the one or more modules depicted in FIG. 3.

The test generator module 310 can generate automated tests to test the functionality of a target application 132. For example, in some embodiments, the test generator module 310 can generate one or more testing scenarios for testing an application. A testing scenario represents a plan to check the interactive functionality of the target application, for example, by filling forms, clicking buttons, viewing screen changes, and otherwise interacting with the various UI elements of an application. A generated testing scenario plan may define a sequence of steps of interaction with the target application 132. As an illustrative example, a generated testing scenario may include 1) start the target application 132; 2) wait, 3) crawl the first page in the UI of the target application 132 to identify one or more interactive elements, 4) interact with each of the identified interactive elements (e.g., click buttons, enter data into fields, etc.), and 5) create additional test scenario plans for every combination of interactive elements on the page, etc. In some embodiments, each step in the test scenario is defined as a data object (e.g., a JavaScript™ Object Notation (JSON) object).

In some embodiments, an automated test for a target application 132 can be configured based on inputs from a developer user 152 received via interface 153. For example, the developer user 152 can specify which types of elements to interact with as part of the test, how long a test executor 314 should wait for a reaction after interacting with an element, which areas of the target application 132 to prioritize for testing, etc. In some embodiments, automated tests can be generated based on one or more rules that specify certain sequences of interaction. A directory of rules may be stored in storage module 308. In some embodiments, the rules used to generate tests may be specific to any of an application, an application type (e.g., an Apple™ iOS app), an industry type (e.g., travel app), etc. As will be described in more detail, in some embodiments, automated tests can be generated based on the recorded interaction with the target application 132 by end users 140.

The test manager module 312 may manage various processes for performing an automated test. For example, the test manager may obtain a generated test scenario from storage module 308, identify tasks associated with the test scenario, assign the tasks to one or more test executors 314 to perform the automated test, and direct test results received from the test executors 314 to a test results generator for processing. In some embodiments, the test manager 312 may coordinate tasks to be performed by a single test executor 314. In other embodiments, the test manager 312 may coordinate multiple test executors (in some cases operating in parallel) to perform the automated test.

The test executor module 314 may execute the one or more tasks associated with an automated test of a target application 132. In an example embodiment, the test executor 314 first requests a next task via any type of interface between the test executor 314 and other components of the automated test platform 300. Such an interface may include, for example, one or more APIs. An entity (e.g., the test manager 312) may then obtain the next task in response to the test executor's 314 request and return the task to the test executor 314 via the interface. In response to receiving the task, the test executor 314 starts an emulator, walks through (i.e., crawls) the target application 132 (e.g., by identifying and interacting with a GUI element) and obtains a test result (e.g., a screen capture of the GUI of the target application 132). The test executor 314 then sends the obtained result (e.g., the screen capture), via the interface, to a storage device (e.g., associated with storage module 308). The test executor 314 can then repeat the process of getting a next task and returning results for the various pages in the UI of the target application 132 until there are no additional pages left, at which point the test executor 313 may send a message indicating that the task is complete.

The test results generator 316 may receive results from the one or more test executors 314, process the results, and generate an output based on the results for presentation to the developer user 152, for example, via interface 153. As previously mentioned, the results returned by the test executor 314 may include screen captures of the UI of the target application 132, for example, at each step in the automated test process. The test results generator 316 may process the received screen captures to, for example, organize the captures into logical flows that correspond with user interaction flows, add graphical augmentations to the screen captures such as highlights, etc. The test results generator 316 may further process results from repeated tests to detect issues such as broken UI elements. For example, by comparing a screen capture from a first automated test to a screen capture from a second automated test, the test results generator may detect that a UI element is broken or otherwise operating incorrectly.

The user interaction recorder module 318 may monitor and record interaction by end users 140 with the target application 132. As will be described in greater detail, the interaction recorder module 318 listens for events (e.g., button click, data entered, page accessed, etc.) from the target application 132 resulting from interaction by an end user 140 with the target application 132 and stores user interaction data indicative of the events in storage module 308.

The user interaction analyzer module 320 can access the user interaction data recorded by the user interaction recorder and process the user interaction data to, for example, organize the events according to user session and timestamp, eliminate events that are not useful to the system such as a user clicking white space, eliminate duplicate events in the same session, generate statistics based on the user interaction (e.g., frequency of interaction with a particular UI element, total number of interactions with a particular UI element, total number of unique users interacting with a particular UI element, etc.), tag or otherwise augment the events with information useful to other components of the system, identify the UI elements associated with target application 132, identify typical user interaction flows with the target application 132, etc.

Various components of automated testing platform 300 may apply machine learning techniques in their respective processes. For example, test generator module 310 may apply machine learning when generating a test scenario to apply to a target application 132. As another example, a test executor 314 may apply machine learning to identify elements in a UI of the target application 132 and may apply machine learning to decide how to interact with such elements. As yet another example, the user interaction analyzer module 320 may apply machine learning to discover patterns in user interactions with the target application 132.

In any case, the machine learning module 322 may facilitate the generation, training, deployment, management and/or evaluation of one or more machine learning models that are applied by the various components of automated testing platform 300. In some embodiments, various machine learning models are generated, trained, and stored in a model repository in storage module 308 to be accessed by other modules. Examples of machine learning algorithms that may be applied by the machine learning models associated with machine learning module 322 include Naïve Bayes classifiers, support vector machines, random forests, artificial neural networks, etc. The specific type of machine learning algorithm applied in any use case will depend on the requirements of the use case.

### Example Automated Testing Process

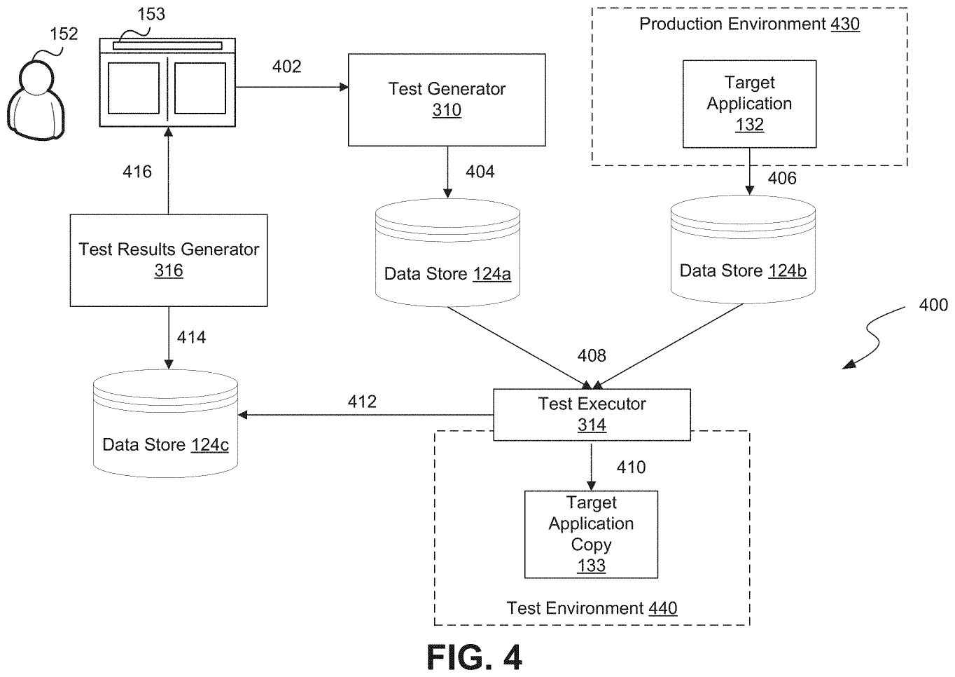

FIG. 4 is an architecture flow diagram that illustrates an example automated testing process. The example process 400 is described with reference to components of an automated testing platform 120, 220, 300 that are described with respect to FIGS. 1-3 (respectively).

Example process 400 begins at operation 402 with a developer user 152 providing inputs, via interface 153, to configure a new automated test of a target application 132. As depicted in FIG. 4, the target application 132 is deployed in a production environment 430 (e.g., hosted by an application server 130) and may be accessible by one or more end users 142. The production environment 430 may represent an environment where the target application 132 is available to the general public or may represent some sort of closed production environment that is only accessible to a select set of end users (e.g., Quality Assurance (QA) testers). In any case, the production environment 430 may include or otherwise mimic the conditions under which the target application 132 with be accessed by an intended set of end users.

The test generator 310 then uses the inputs provided at operation 402 to generate one or more testing scenarios for the target application 132, and at operation 404, the test generator 310 stores test data indicative of the generated testing scenarios in data store 124a. As previously discussed, each testing scenario may define a sequence of tasks with each task represented in a data object (e.g., a JSON object).

At operation 406, application files associated with target application 132 are uploaded from the production environment 430 and stored at data store 124b. The application files uploaded to data store 124b may comprise the entire target application and/or some portion thereof. For example, in the case of a website, the uploaded files may include one or more files in Hypertext Markup Language (HTML) that can then be tested using one or more different browser applications stored in the automated testing platform. In some embodiments, a test manger 312 (not shown in FIG. 4) coordinates the uploading of test files from the production environment 430.

At operation 408, a test executor 314 downloads data indicative of a stored testing scenario from data store 124a and the stored application files from data store 124b and at operation 410 initiates testing of a target application copy 133 in a separate test environment 440. The test environment 440 may be part of a virtual machine configured to mimic the computer system or systems hosting the production environment 430. Again, although not depicted in FIG. 4, in some embodiments, a test manager 312 may coordinate the initiation of the test environment 440 and the download of the application files into the test environment 440. In some embodiments, an emulator (e.g., browser emulator, operating system emulator, etc.) is initiated in the test environment 440 to facilitate automated testing of the target application 133.

In some embodiments, the process of testing by the test executor 314 may include obtaining a task from a test manager 312, walking through the application 133 (e.g., by identifying and interacting with UI elements) and obtaining test results such as screen captures of the UI of the application 133 before, during, and/or after interaction with the various UI elements. The test results (e.g., screen captures) obtained by the test executor 314 can then be stored, at operation 412, in data store 124c. This process of storing test results at operation 412 may be performed continually as test results are obtained or at regular or irregular intervals until all the pages in the target application 133 have been tested or the defined task is otherwise complete.

Notably, in some embodiments, the obtained task may only specify a high-level task to be performed by the test executor 314 as opposed to specific instructions on how to perform the task. In such cases, a test executor may apply artificial intelligence techniques to perform a given task. For example, in response to receiving a task to enter a value in a search field, the test executor 314 may, using artificial intelligence processing, crawl the various UI elements associated with a target application 132 to identify a particular UI element that is likely to be associated with a search field. In some embodiments, this may include processing various characteristics associated with a UI element (e.g., type of element (field, button, pull-down menu, etc.), location on a page, element identifier, user-visible label, etc.) using a machine learning model to determine what a particular UI element is.

At operation 414, the test results generator 316 accesses the test results stored in data store 124c for further processing. For example, test results generator 316 may process accessed test results to, for example, organize screen captures into logical flows that correspond with user interaction flows, add graphical augmentations to the screen captures such as highlights, etc. The test results generator 316 may also access test results from a previous test of the target application 132 to compare the new test results to previous test results. For example, by comparing a screen capture from a first automated test to a screen capture from a second automated test, the test results generator 316 may detect that a UI element associated with target application 132 is broken or otherwise operating incorrectly.

Finally, at operation 416, the test results generator may cause display of a set of processed test results to the developer user 152 via interface 153. Again, the processed test results may include screen captures of the UI of the target application 132 that are organized into logical flows, indicators of UI elements that are broken or otherwise operating incorrectly, etc.

The process depicted in FIG. 4 is an example provided for illustrative purposes and is not to be construed as limiting. Other processes may include more or fewer operations and/or may involve more or fewer components than are depicted in FIG. 4 while remaining within the scope of the present disclosure. For example, although depicted in FIG. 4 as separate entities, data stores 124a-c may be part of an overall system data store (e.g., data store 124 of FIG. 1) and/or may represent more than three separate data storage devices.

Recording User Interaction with the Target Application

As previously discussed, one or more end users 142 may access and interact with a target application, for example, by using a network-connected end user device 140. For example, an end user 142 may access a website or web app and interact with various buttons, pull down menus, Tillable forms, etc. This user interaction with the target application 132 can be monitored and recorded to inform various processes associated with an automated testing platform 120 such as automated test generation.

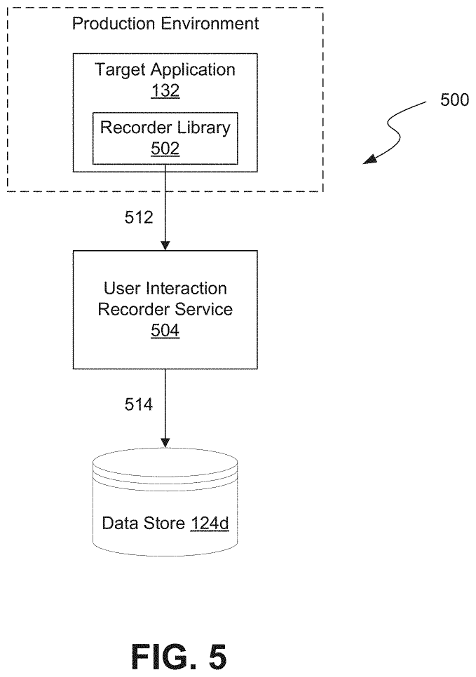

FIG. 5 shows an architecture flow diagram 500 that illustrates an example process for recording user interaction with a target application 132. As shown in FIG. 5, a recorder library 502 is run at the target application 132. Although depicted in FIG. 4 as part of the target application 132, in some embodiments, the recorder library 502 may not be part of the application 132 and may be separately run in a production environment (e.g., production environment 430). In the case of a website, the recorder library 502 may be run at a web browser of an end user 142 accessing the website. For example, the recorder library 502 may be implemented using a script integrated into a website that causes the recorder library 502 (or portion thereof) to be downloaded from a remote location (e.g., a web server) to a web browser application at an end user device 140. The recorder library 502 is configured to monitor, listen for, or otherwise detect, events indicative of interaction by an end user 142 with the target application 132. The events detected by the recorder library 502 can include, for example, an end user 142 accessing the target application, logging in or out of the target application, clicking/tapping a button in a GUI of the target application, entering data to the target application, hovering a cursor over a region of a GUI of the target application, dragging a cursor in a GUI of the target application, etc. In some embodiments, the recorder library 502 is also configured to preprocess detected events to, for example, ignore certain events that are not useful (e.g., a user clicking white space in the UI of the target application 132) and/or eliminate duplicate events. In some embodiments, the events are preprocessed by the recorder library 502 in real time (or near real time) as they occur. In some embodiments, the recorder library 502 may be implemented as a JavaScript™ library.

The recorder library 502 can be installed in a production environment associated with the target application 132 by a provider of the target application. For example, in some embodiments, a developer user 152 may elect to download the recorder library 502 from a server associated with the automated testing platform 120 and implement the recorder library 502 as part of a target application 132 in a production environment. In some embodiments, the automated testing platform 120 may provide options, via interface 153, to a developer user 152 to configure how the recorder library 502 operates and communicates with other services associated with the automated testing platform 120. For example, using interface 153, a developer user 152 may specify what types of events the recorder library 502 listens for, how events are preprocessed by the recorder library 502, and/or which events are communicated as user interaction data to the automated testing platform 120.

At operation 512, the recorder library 502 transmits user interaction data (e.g., via a websocket) indicative of the detected events to a recorder service 504. The user interaction data may include, for example, the raw and/or preprocessed events detected by the recorder library 502 and/or new data generated by the recorder library 502 based on the detected events.

The recorder service 504 is configured to receive user interaction data from the recorder library 502 and at operation 514 store the user interaction data in data store 124d where the user interaction data is accessible to other services such as test generator 310, test manager 312, test executor 316, user interaction analyzer 320, etc. In some embodiments, data store 124d is part of an overall system data store (e.g., data store 124 of FIG. 1).

In some embodiments, the recorder service 504 is configured to group user interaction data based on individual users and/or user sessions. For example, recorder service 504 may read session information included in the user interaction data received from the recorder library 502 and store the user interaction data in a record in data store 124d associated with a new or existing user session. A user session in this context may refer to a bounded series of interactions by a particular end user 142 with the target application 132. A session may be bounded, for example, by detected events such as the end user 142 logging in and out of the target application 132 (i.e., a login session). A session may also be bound based according to a set period of time (e.g., daily session, etc.). In some embodiments, the developer user 152 can configure how sessions are bounded (e.g., a maximum recording session time) using interface 153. In some embodiments, machine learning may be applied to user interaction data to learn usage patterns and dynamically update how user sessions are bounded.

In some embodiments, the components associated with user interaction recording (e.g., recorder library 502 and/or recorder service 504) are provided as part of the automated testing platform 120. In other words, such recording components may be integrated into a testing system and provided by a testing system provider. Alternatively, such components may be provided by a third-party provider that is otherwise unaffiliated with the testing system provider such as a third-party event processing or analytics system.

### Generating and Executing Automated Tests Based on Recorded User Interaction Data

Recorded user interaction data can be utilized by the automated testing platform for various purposes such as identifying patterns in user interaction with the target application 132, training a machine learning model that is specific to the target application 132, generating customized automated tests for the target application 132 (and other applications), etc. In some cases, by specifically tailoring an automated test for a target application 132 based on user interaction data, the overall number of test scenarios performed can be reduced, for example, by avoiding user interaction scenarios that are seldom observed.

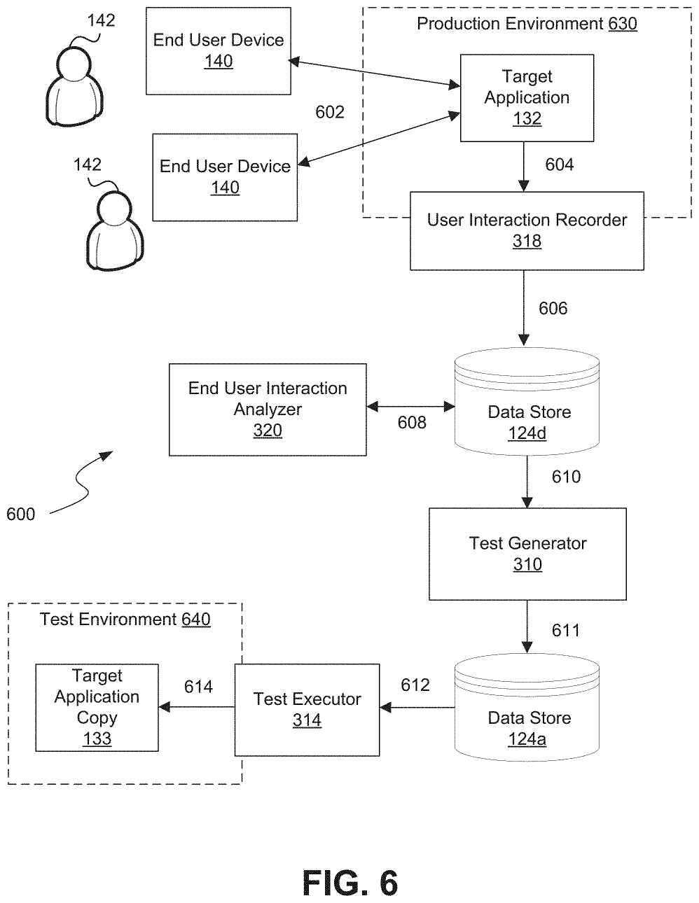

FIG. 6 shows an architecture flow diagram of an example process 600 for generating and executing automated tests based on recorded user interaction data. As shown in FIG. 6, a target application 132 is deployed in a production environment 630 (analogous to production environment 430) and is accessible to one or more end users 142, for example, via end user devices 140.

At operation 602, the one or more end users 142 interact with the target application 132, for example, by inputting commands and receiving outputs via a UI of the target application 132. In some embodiments, the input commands and outputs are communicated over a computer network (not shown in FIG. 6).

At operation 604, a user interaction recorder 318 records user interaction data indicative of the interaction by the one or more end users 142 with the target application 132, for example, as described with respect to FIG. 5. Although not depicted in FIG. 6, the user interaction recorder 318 may include the recorder library 502 running in the production environment 630 as well as the recorder service 504 that is receiving user interaction data from the recorder library 502.

At operation 606, the user interaction recorder 318 stores the user iteration data in a data store 124d where the user interaction data is accessible to other services such as a test generator 310, a test executor 314, and/or an end user interaction analyzer 320.

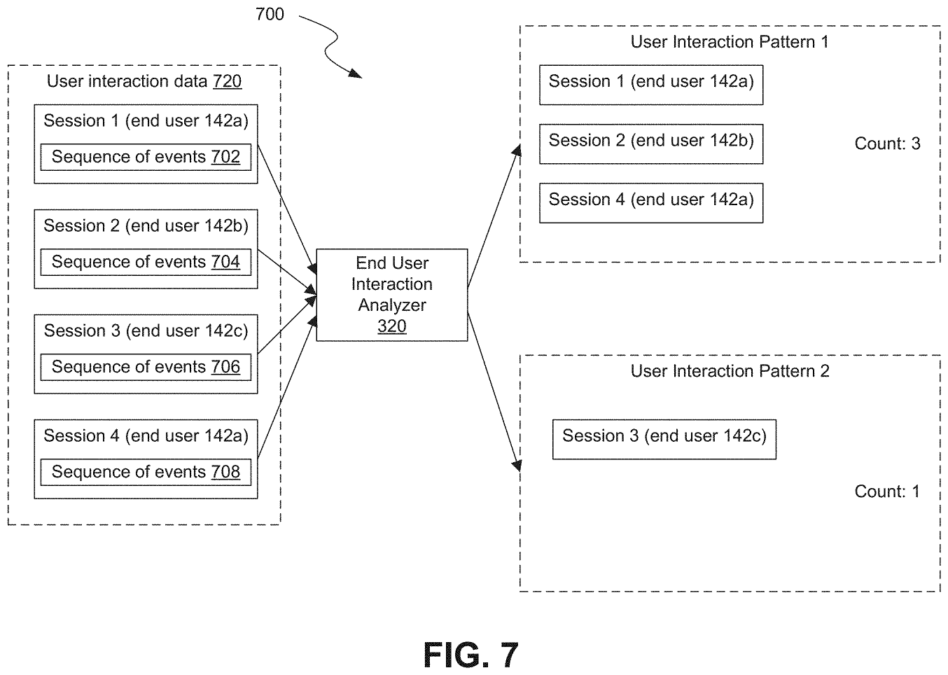

At operation 608, an end user interaction analyzer 320 optionally accesses at least some of the user interaction data from data store 124d for further processing. The end user interaction analyzer 320 may process user interaction data to, for example, group similar user interaction flows, identify common or representative user interaction flows, identify statistically rare user interaction flows, identify other user interaction patterns, and/or extract any other useful information from the recorded user interaction data. An example process for analyzing user interaction data is described with respect to FIG. 7.

The results of the processing by the end user interaction analyzer 320 can optionally be stored in data store 124d for access by other services such as a test generator 310 or test executor 314. In some embodiments, the results of the processing by the end user interaction analyzer 320 may be stored as new user interaction data. New user interaction data may include, for example, continually updated statistics regarding various types of user interaction patterns occurring at the target application 132 (e.g., total number of each type of user interaction pattern occurring, average daily occurrence of each type of user interaction pattern, maximum/minimum daily occurrence of each type of user interaction pattern, similarity between unique sessions falling under a particular user interaction pattern, etc.). In some embodiments, the results of the processing may include supplementation or augmentation of the existing user interaction data stored at data store 124d. For example, sequences of events associated with a given user session may be tagged as being associated with a particular type of user interaction pattern. These tags can then be used by other services (e.g., test generator 310) to perform separate analysis of the frequency, timing, etc. associated with various types of user interaction patterns.

At operation 610, a test generator 310 may access user interaction data stored in data store 124, process the user interaction data, and generate one or more automated tests based on the processing. As previously mentioned, the user interaction data processed by the test generator 310 may include the user interaction data recorded by the user interaction recorder 318 and/or the results of processing such interaction data by an end user interaction analyzer 320.

As previously discussed with respect to FIG. 3, generating an automated test may include generating a test scenario that defines a sequence of steps of interaction with a target application 132 to test the functionality of a UI associated with the target application. Here, the testing scenarios can be specifically tailored for the target application 132 based on the recorded end user interactions with the target application 132. For example, if the target application 132 is a travel app, a common or typical user interaction pattern through the target application 132 may include a flight search (as described above). Based on this information, the test generator 310 may specify a testing scenario configured to test the functionality of a UI of target application 132 when performing a search for a flight. This testing scenario may define a sequence of steps (e.g., enter departure date, enter return date, press search button, wait for search result including listing of flights, press button to sort by price, etc.).

In some embodiments, the automated test generated by the test generator 310 based on the user interaction data may include fewer than all of the possible testing scenarios associated with the target application 132. For example, testing scenarios included in an automated test may be based on only those user interaction patterns that satisfy a testing criterion. For example, a testing criterion may specify a threshold (e.g., based on count, frequency, percentage, etc.) for determining whether to test a given user interaction pattern. As an illustrative example, the test generator 310 may generate an automated test including a particular testing scenario in response to determining that a particular user interaction pattern corresponding to the particular testing scenario accounts for at least 60% of all types of user interaction patterns observed over a given timeframe (e.g., one month). As another illustrative example, the test generator 310 may generate an automated test including a particular testing scenario in response to determining that an observed user interaction pattern corresponding to the testing scenario occurred at least once per minute over a given timeframe (e.g., one day). As another illustrative example, the test generator 310 may generate an automated test that includes one or more of the most frequent user interaction patterns. These are just example testing criteria provided for illustrative purposes and are not to be construed as limiting. Other types of testing criteria can similarly be applied to determine what types of testing scenarios to apply as part of an automated test.

In addition to configuring one or more testing scenarios based on the user interaction data, the test generator 320 may prioritize how certain testing scenarios are performed. For example, the test generator 320 may prioritize a testing scenario associated with a search for a flight if the user interaction data indicates that most users spend the majority of their time in the target application 132 searching for flights. Prioritizing a particular testing scenario in this context may include, for example, designating that the particular testing scenario be performed before other testing scenarios, designating that computing resources be allocated to performing the particular testing scenario over other testing scenarios, designating that the particular testing scenario be performed again more frequently than other testing scenarios, etc.

In some embodiments, testing criteria can be user configurable. For example, using interface 153, a developer user 152 associated with target application 132 may set various threshold values that are used by the test generator 310 to determine which testing scenarios to include in an automated test, for example, as described with respect to FIG. 4. In some embodiments, the developer user 152 may set such threshold values indirectly, for example, by indicating an overall level of testing to perform (e.g., ranging from all testing scenarios to selectively targeted testing scenarios). For example, in response to the developer user 152 providing an input indicative of a level of testing to perform, the platform 120 may set one or more threshold values that are used by the test generator 310 to determine which testing scenarios to include in an automated test.

In some embodiments, the test generator 310 may apply machine learning techniques to generate automated tests based on user interaction data. For example, user interaction data (or identified usage patterns may be input into a machine learning model configured to identify which usage patterns are the most important to test (even if such tests are not necessarily the most frequent). In such an example, the machine learning model may be conjured to generate, based on input user interaction data, one or more similarity scores that are each indicative of a level of similarity with one or more predefined testing scenarios. The predefined testing scenarios may have been determined (by the developer user 152 or some other entity) to be important to testing an application. The test generator 310 can then identify, based on the generated similarity scores, one or more of the predefined testing scenarios that match the detected usage patterns (e.g., all testing scenarios with corresponding similarity scores above a threshold value). The test generator 310 can then generate an automated test that includes the identified predefined testing scenarios. In some embodiments, historical user interaction data stored in data store 124d can be used to train a machine learning model applied by test generator 310.

At operation 611, the test generator 310 stores testing data indicative of a generated test, for example, in data store 124a where it can be accessed by other services such as a test manager 312 and/or a test executor 314 for performing the automated test. As previously discussed, testing scenarios defining sequences of interaction steps may be represented as a data object (e.g., a JSON object). Accordingly, the test generator 310 may generate and store a data object in data store 124a that defines the one or more testing scenarios to perform as part of an automated test. This data object defining an automated test may be specifically and only applied to perform automated tests of target application 132 or may also be applied to perform automated tests of other applications (e.g., of similar type such as other travel apps).

At operation 612, a test executor 314 is run to execute the one or more scenarios associated with an automated test. For example, in response to receiving a command from a developer user 152 to initiate an automated test, the test executor 314 may obtain one or more tasks based on generated testing scenarios stored in data store 124, for example, as described with respect to FIG. 4. In an illustrative example, a test manager 312 may read a data object stored in data store 124a that defines a testing scenario to be performed, generate a task based on the testing scenario, and transmit that task to the test executor 314 to perform the task.

At operation 614, the test executor 314 may perform a test of the target application based on a received task, for example, as described with respect to FIG. 4. Notably, in some embodiments, the test of the target application may be performed using a copy 133 in a test environment 640 (analogous to test environment 440) that is separate from the production environment 630, for example, as described with respect to FIG. 4. In other words, example process 600 may include recording user interaction with a target application 132 in a production environment 630 to generate automated tests that are performed using a copy 133 of the target application in a separate test environment 640.

The process depicted in FIG. 6 is an example provided for illustrative purposes and is not to be construed as limiting. Other processes may include more or fewer operations and/or may involve more or fewer components than are depicted in FIG. 6 while remaining within the scope of the present disclosure. Certain operations and/or components may be omitted from the process depicted in FIG. 6 for illustrative simplicity and clarity. For example, although not depicted in FIG. 6, the target application copy 133 may be downloaded from the production environment 630 and stored in a data store 124b where it can be accessed and placed into the test environment 640, for example, as described with respect to FIG. 4. Further, although not depicted in FIG. 6, the test executor 314 may store results of the test of the target application in a data store 124c that can then be accessed by a test results generator 316, for example, as described with respect to FIG. 4. Still further, although depicted as separate entities, data stores 124a-d may be part of an overall system data store (e.g., data store 124 of FIG. 1) and/or may represent more than four separate data storage devices.

FIG. 7 is a flow diagram that illustrates an example process 700 for analyzing user interaction data. As shown in FIG. 7, the end user interaction analyzer 320 may access user interaction data 720 from, for example, data store 124d. In this example, the user interaction data 720 includes sequences of timestamped events (e.g., recorded by recorder library 502) that are grouped according to user session. As previously discussed, events comprising the user interaction data 720 may be grouped by a recorder service 504 into various sessions. Here, user session 1 (by a first end user 142a) includes a sequence of timestamped events 702, user session 2 (by a second end user 142b) includes a sequence of timestamped events 704, user session 3 (by a third end user 142c) includes a sequence of timestamped events 706, and user session 4 (by the first end user 142a—i.e., the same as in session 1) includes a sequence of timestamped events 708. The sessions can be anonymized. For example, although grouped accordingly to various end users 142a-c, the interaction data 720 may not include any personally identifiable information (PII) associated with such users.

The user interaction data 720 in this example can be processed by end user interaction analyzer 320 to group the various sessions according to one or more discovered user interaction patterns. In this example, sessions 1, 2, and 4 are assigned to user interaction pattern 1 based on the processing, and session 3 is assigned to user interaction pattern 2 based on the processing. Each of the user interaction pattern groups may be associated with some discovered logical pattern in user interaction with the target application. As an illustrative example, user interaction pattern 1 may be associated with a user interaction flow for searching flights, and user interaction pattern 2 may be associated with a user interaction flow for entering feedback comments. According to this illustrative example, the end user interaction analyzer 320 has determined that sessions 1, 2, and 4 can be categorized as a user searching for flights and that session 3 can be characterized as a user entering feedback commentary. As shown, the end user interaction analyzer 320 has determined an occurrence count of 3 for user interaction pattern 1 and an occurrence count of 1 for user interaction pattern 2. Therefore, over a similar timeframe, it can be determined that user interaction pattern 1 is more frequently observed than user interaction pattern 2.

The manner in which user interaction data 720 is analyzed may differ in various embodiments. In some embodiments, the end user interaction analyzer 320 may apply one or more rules to user interaction data to group user sessions into defined user interaction patterns. The rules associated with the user interaction patterns may include similarity criteria that can be applied to sequences of events in the user interaction data to determine whether the sequence of events is associated with a given user interaction pattern. For example, a rule for a “flight search” user interaction pattern may specify a sequence of specific interaction steps such as enter departure date, enter return date, press search button, select search result, etc. The rule may further specify some similarity criterion for determining whether a recorded sequence of events in a given user session can be categorized as a “flight search” user interaction. The similarity criterion may be based on the types of events, the timing of the events, the sequencing of the events, etc. For example, a similarity criterion may specify that a sequence of events in a given user session can be categorized as a “flight search” user interaction in response to determining that the sequence of events include at least 60% of the following events: enter departure date, enter return date, press search button, and/or select search result. Notably, the sequence of events for each user session need not be exactly the same as each other to be categorized as belonging to a particular user interaction pattern. For example, the sequence of events 802 included in session 1 may include events indicative of end user 142a interacting with a UI element that is unrelated to a flight search (e.g., clicking a “privacy policy” link). Although the other sessions 2 and 4 may not include such events, the three sessions may nevertheless be categorized as flight searches as long as the other events (e.g., enter departure date, enter return date, press search button, select search result, etc.) satisfy a particular similarity criterion. This is just an example similarity criterion that is provided for illustrative purposes. Actual similarity criteria may differ in other embodiments.

In some embodiments, the end user interaction analyzer 320 may apply machine learning techniques to process the user interaction data 720. For example, user interaction data may be input into a machine learning model configured to classify each recorded user session as belonging to one of one or more user interaction patterns, for example, using a clustering algorithm. In some embodiments, user interaction data may be input into a machine learning model configured to predict an intention of an end user associated with a given user session and thereby classify the type of user interaction based on the predicted intention. Other types of machine learning techniques may similarly be applied. In some embodiments, historical user interaction data stored in data store 124d can be used to train a machine learning model applied by the end user interaction analyzer 320.

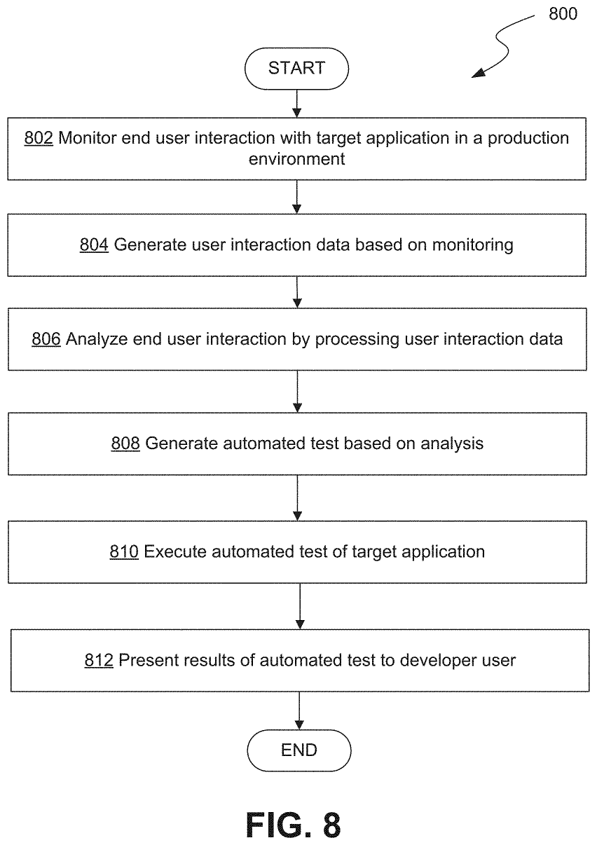

FIG. 8 shows a flow diagram of an example process 800 for generating and performing automated tests of a target application 132 based on recorded user interaction with the target application 132 in a production environment.

Example process 800 can be executed by one or more of the components of an automated testing platform 120. In some embodiments, the example process 800 depicted in FIG. 8 may be represented in instructions stored in memory that are then executed by a processor. The process 800 described with respect to FIG. 8 is an example provided for illustrative purposes and is not to be construed as limiting. Other processes may include more or fewer operations than depicted, while remaining within the scope of the present disclosure. Further, the operations depicted in example process 800 may be performed in a different order than is shown.

Example process 800 begins at operation 802 with monitoring end user interaction with a target application in a production environment. For example, as described with respect to FIG. 6, a user interaction recorder 318 may monitor interaction by end users 142 with a target application 132 in a production environment 630. In some embodiments, the interaction recorder 318 may include a recorder library 502 running in the production environment 630 as well as a recorder service 504 configured to received communications from the recorder library, for example, as described with respect to FIG. 5. Accordingly, in some embodiments, monitoring end user interaction with the target application may include receiving (e.g., by the recording service 504) communications from the recorder library 502 running in the production environment 630 (e.g., running in target application 132). The received communications may be indicative of one or more user interaction events detected by the recorder library 602 based on the interaction by end users 142 with the target application 132.

Example process 800 continues at operation 804 with generating user interaction data based on the monitored end user interaction with the target application. For example, as described with respect to FIG. 6, the user interaction recorder 318 can generate and store user interaction data in a data store 124d. In some embodiments, the user interaction data may just include data indicative of the events detected by a recorder library 502. In some embodiments, generating the user interaction data may include grouping (e.g., by user interaction recorder 318) detected user interaction events based on identified user sessions.

Example process 800 continues at operation 806 with analyzing user interaction with the target application 132 by processing the user interaction data. For example, as described with respect to FIG. 6, an end user interaction analyzer 320 may access user interaction data from data store 124d for processing. In some embodiments, analyzing user interaction with the target application 132 may include processing the user interaction data to discover patterns in the user interaction with the target application 132. As mentioned, in some embodiments, the user interaction data may be organized based on identified user sessions. In such cases, the record of each identified user session may include a sequence of time-stamped user interaction events. Accordingly, in such embodiments, processing the user interaction data may include grouping each of the identified user sessions into one of multiple discovered user interaction patterns based on the sequence of time-stamped events included in the respective identified user sessions, for example, as described with respect to FIG. 7.

Example process 800 continues at operation 808 with generating an automated test of the target application based on the analysis of the user interaction with the target application. For example, as described with respect to FIG. 6, a test generator 310 may access from data store 124d results of processing the user interaction data by end user interaction analyzer 320. In some embodiments, the test generator 310 may perform its own analysis of user interaction instead of or in addition to end user interaction analyzer 320. In some embodiments, generating the automated test may include generating one or more testing scenarios that correspond with a user interaction pattern discovered based on the processing of the user interaction data. As previously discussed, each of the one or more testing scenarios may define a sequence of steps of interaction with one or more interactive elements of a GUI of the target application.

In some embodiments, generating the automated test may include generating a testing scenario that corresponds with a discovered user interaction pattern in response to determining that the discovered user interaction pattern satisfies one or more testing criteria. In some embodiments, a testing criterion may specify a threshold associated with a user interaction pattern based, for example, on any of: a total number of user interactions with the target application that match the user interaction pattern; a frequency of user interactions with the target application that match the user interaction pattern; or a percentage of all user interactions with the target application that match the user interaction pattern. For example, if, based on the analysis of user interaction with a target application, it is determined that a total number of user sessions that match the user interaction pattern exceed a threshold amount for a given time period, the test generator 310 will generate an automated test that includes a testing scenario that corresponds with the user interaction pattern.

In some embodiments, generating the automated test of the target application may also include prioritizing a testing scenario corresponding with a detected user interaction pattern. In such cases, prioritizing the testing scenario may include any of: designating that the testing scenario is to be performed before or instead of performing a different testing scenario when executing an automated test, designating computing resources to be allocated to performing the testing scenario over performing a different testing scenario when executing the automated test; or designating that the testing scenario is to be performed again more frequently than a different testing scenario when executing an automated test.

Example process 800 continues at operation 810 with executing the automated test of the target application. For example, as described with respect to FIG. 6, a test executor 314 may execute the automated test, for example, by receiving tasks from a test manager 312 based on an automated test generated by test generator 310. In some embodiments, the automated test of the target application is executed in a test environment that is different than the production environment in which the target application is running. Accordingly, in such embodiments, executing the automated test of the target application may include downloading necessary files (e.g., a copy of the target application) to the test environment to perform the automated test.

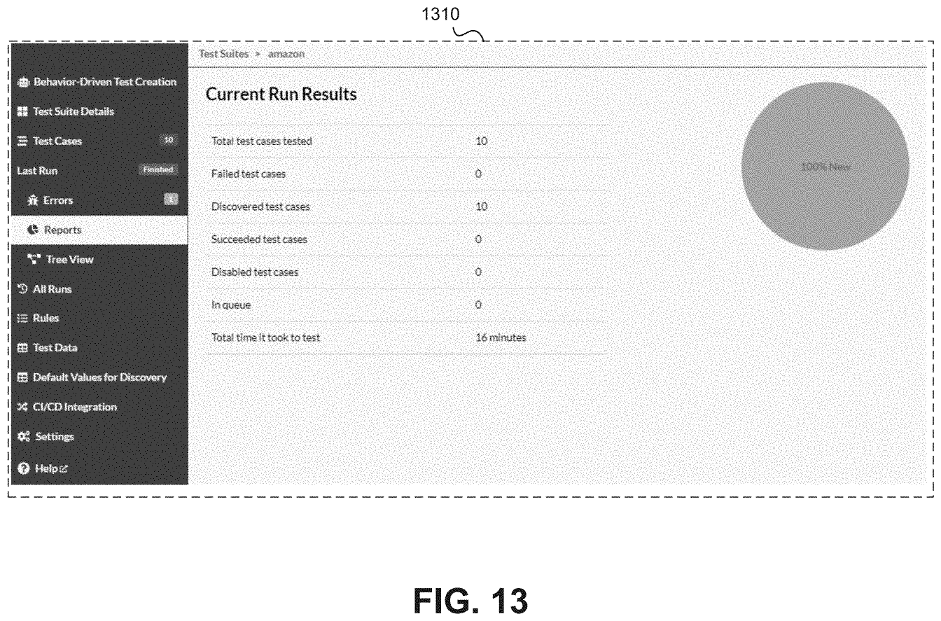

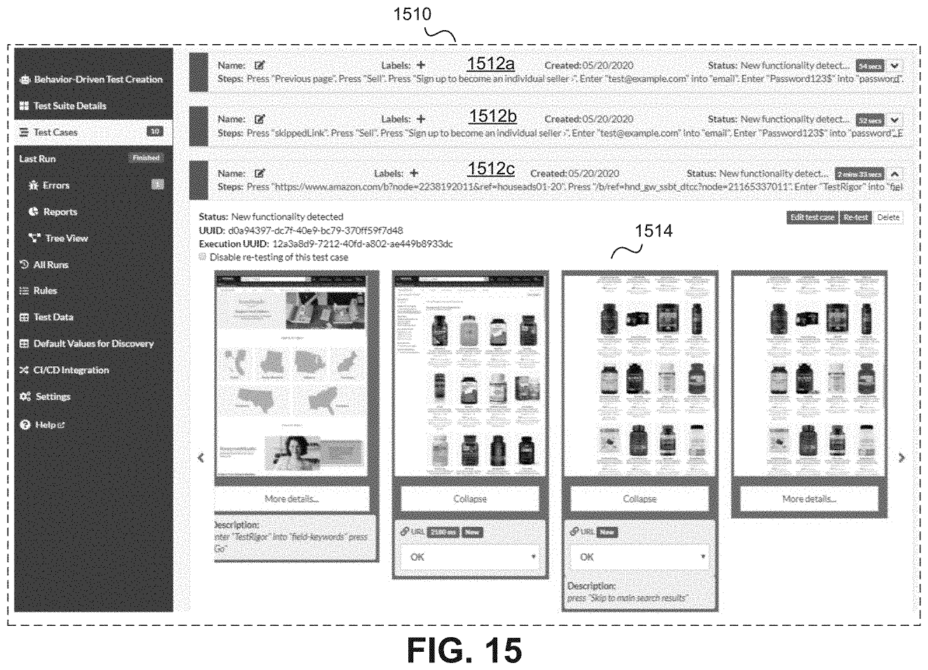

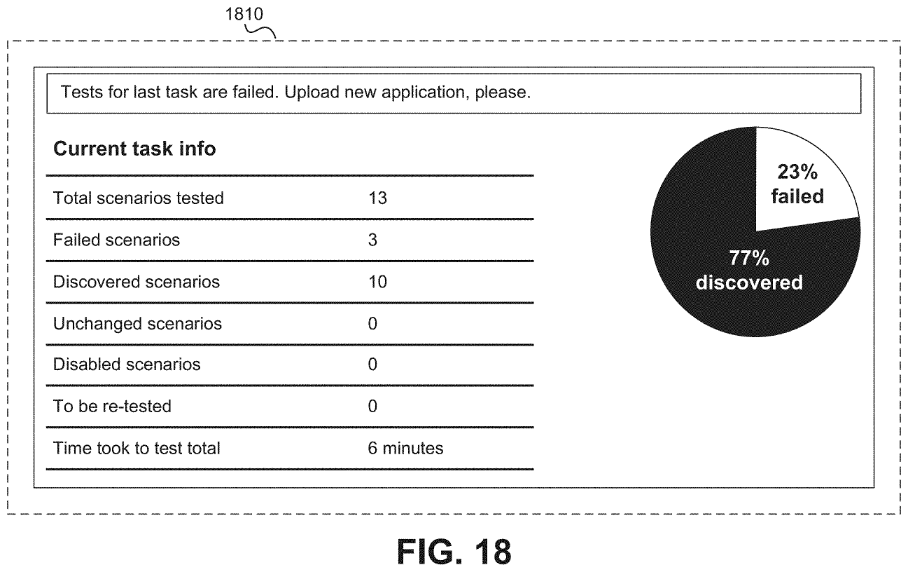

Example process 800 concludes at operation 812 with generating results based on the execution of the automated test and presenting the results to a user. For example, results of the automated test may be displayed to a developer user 152 via interface 153. In some embodiments, generating the results of the automated test may include compiling a summary of the automated test and displaying the summary to the developer user 152. For example, FIGS. 13 and 18 show example summaries of test results that may be presented to a developer user 152, for example, via interface 153. In some embodiments, generating the results of the automated test may include capturing one or more screen captures of a GUI of the target application during the process of executing the automated test. The screen captures may depict the various states of the GUI of the target application, for example, as the test executor 314 interacts with the various interactive elements in the GUI of the target application. For example, FIGS. 15, 16, 17, and 19 show example results including screen captures that may be presented to a developer user 152, for example, via interface 153.

### Example Graphical User Interface

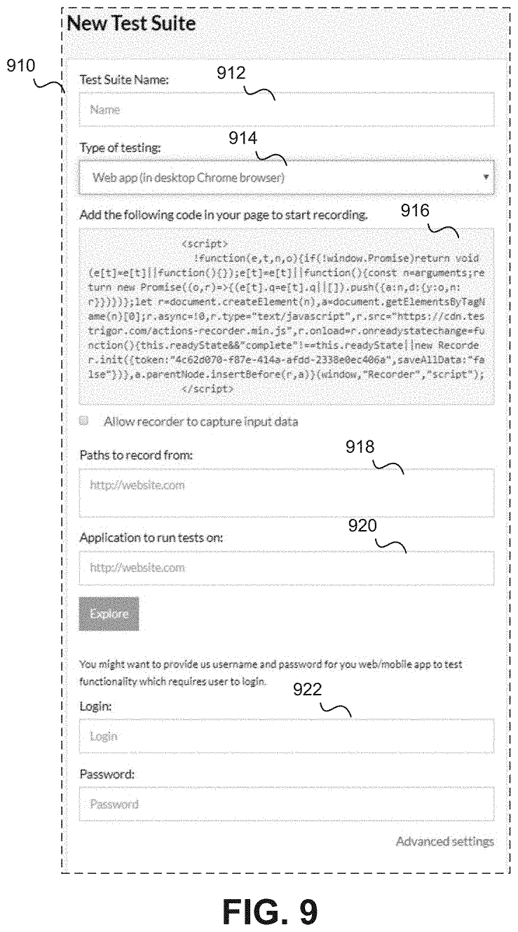

FIGS. 9-19 show a series of screens associated with an example developer GUI associated with automated testing platform 120. In other words, the example developer GUI depicted in FIGS. 9-19 may correspond with the interface 153 described with respect to FIG. 1 and may be utilized by a developer user 152 to perform automated testing of a target application 132. Accordingly, the developer GUI depicted in FIGS. 9-19 may be presented via a display associated with a developer user computing device 150. Note that the included screen captures depicted in FIGS. 9-19 are provided for illustrative purposes to show certain example features of a developer GUI associated with automated testing platform 120 and are not intended to be limiting. Some embodiments may include fewer or more user interaction features than are described with respect to FIGS. 9-19 while remaining within the scope of the introduced technique.

FIG. 9 shows an example screen 910 of the example developer GUI that may be presented to a developer user 152 when setting up a new automated test. For example, in response to logging in to, or otherwise accessing, automated testing platform 120, a developer user 152 is presented with screen 910 which includes a prompt to add a new application for testing. The example prompt depicted in screen 910 includes an editable field 912 to input a test name and an interactive element 914 through which a developer user 152 can specify the type of application to be tested. For example, the interactive element 914 is depicted in FIG. 9 in the form of a pull-down menu that allows the developer user 152 to select from multiple defined application types such as a website (in a desktop version of the Chrome™ browser), a website (in an Android™ version of the Chrome™ browser), an Android™ application, and an Apple™ iOS application. These are just example application types shown for illustrative purposes. Other application types may similarly be included in the prompt associated with screen 910.

Example screen 910 also includes a text-based script 916 that the developer user can copy and place into the code of their application (e.g., website) to facilitate recording user interaction with the application. In some embodiments, such as script is provided when the developer user 152 selects, via element 914, a website as the application type. Other mechanisms for facilitating recording user interaction may be provided for other application types. For example, if the developer user 152 selects an iOS application as the application type a different type of mechanism such as a link to download a recorder library may be provided to facilitate recording user interactions.

Example screen 910 also include interactive elements through which a user can specify the paths from which to record user interactions and the application to be tested. For example, interactive element 918 is an editable text field through which the developer user 152 can input a uniform resource locator (URL) associated with a website to specify a path from which to record user interaction data. Similarly, interactive element 920 is an editable text field through which the developer user 152 can input a URL of the website to be tests. In the example depicted in FIG. 9, both URLs are the same; however, this may not be the case in all scenarios. Further, if the application is not a website (e.g., an iOS application) elements 918 and/or 920 may be replaced with a different UI element that enables the developer user 152 to upload a copy of the application, input a link to download the application, or otherwise enable access to the application.

In some cases, the target application 132 may be associated with some type of login or other authentication protection. In such cases, the developer GUI may prompt the developer user 152 to input necessary authentication information such as HTTP authentication login and password, application login and password, etc. For example, element 922 in screen 910 prompts the developer user 152 to input login and password information for the website.

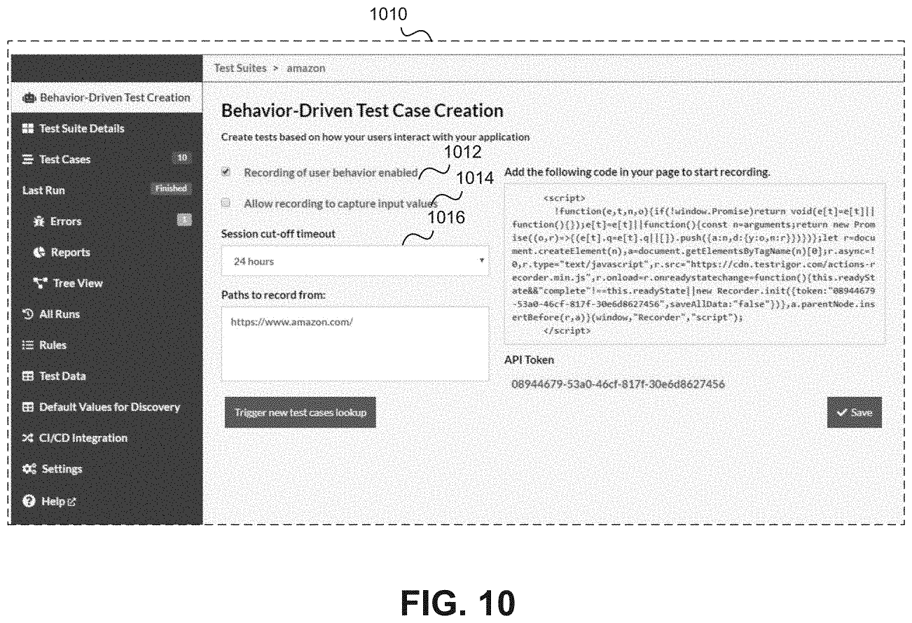

In some embodiments, the developer GUI may present options to the developer user 152 to specifically configure various characteristics of an automated testing process. FIG. 10 shows a screen 1010 for configuring a behavior-driven automated test. As shown in FIG. 10, screen 1010 depicts certain aspects of the test to be created such as the user interaction recording script and the path to record from that were previously described with respect to FIG. 9. Screen 1010 also includes options (e.g., in the form or toggle buttons) to enable the recording of user behavior (button 1012) and to enable the recording of values input by users when using the application (button 1014). Such values input by users may include, for example, search terms or other information. When recording values input by users, mechanisms can be implemented to ensure user privacy. For example, such values may be anonymized by actively removing any PPI included in the data. Screen 1010 also shows an option 1016 to select a session cut-off timeout. Using option 1016, the develop user 152 can specify how long to record user interaction during a session before cutting off recording. In the example depicted in FIG. 10, the session cut-off timeout is set to 24 hours; however, this can be set to any value.

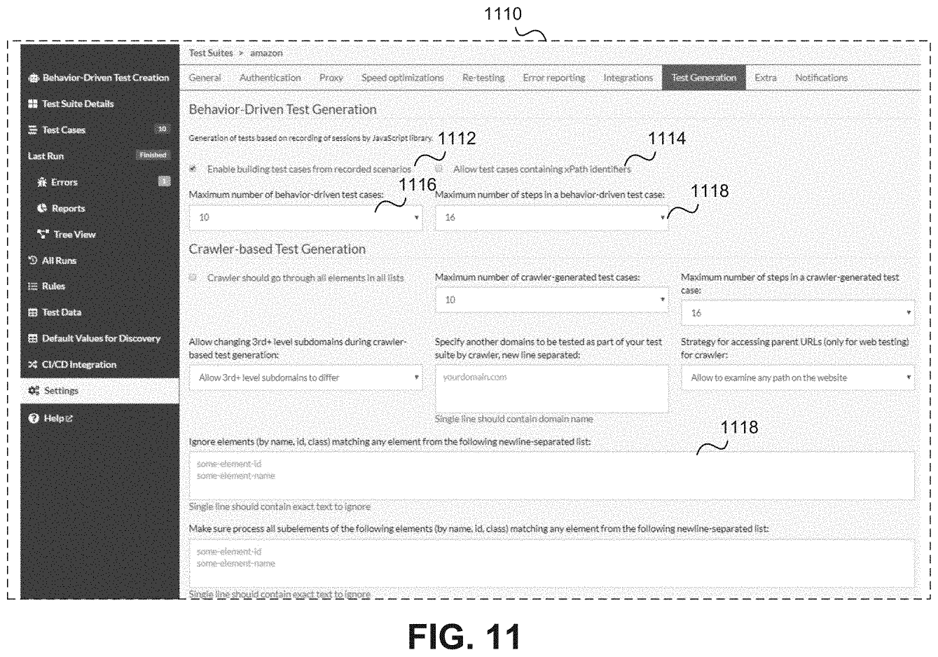

FIG. 11 shows another screen for configuring an automated test. Specifically, FIG. 11 shows a screen 1110 of an example developer GUI that includes various interactive elements through which the developer user can set test parameters for generating an automated test based on user interaction data. As shown in FIG. 11, screen 1110 includes options (e.g., in the form or toggle buttons) to enable building tests from recorded scenarios (button 1112) and to allows test scenarios containing certain xPath identifiers (button 1114).

Screen 1110 further includes options to set the maximum number of behavior-driven tests cases (pull down menu 1116) and to set the maximum number of steps in a behavior-driven test scenario (button 1118). For example, using option 1116, the develop user 152 may set the maximum number of behavior-driven test scenarios to 10. In response, the system may automatically generate an automated test that includes up to 10 different test scenarios. The up to 10 different test scenarios may correspond, for example, to the 10 most frequent user interaction patterns indicated in recorded user interaction data. The number of steps in a given test scenario may correspond to individual user interactions. For example, if the maximum number of steps is set to 16, the system may generate a test scenario that includes up to 16 different steps (e.g., press button, enter data, press next button, etc.). Again, the steps in a given test scenario may, in some embodiments, correspond to the most frequently observer steps taken by actual end users based on the user interaction data.

To streamline testing, a developer user may also specify certain elements in the target application to ignore during an automated test. For example, interactive element 1118 includes an editable text field into which a developer user can input one or more element identifiers that reference certain elements (e.g., UI elements or other assets) in the target application that are to be ignored during testing. The element identifiers may reference specific elements and/or classes of elements.

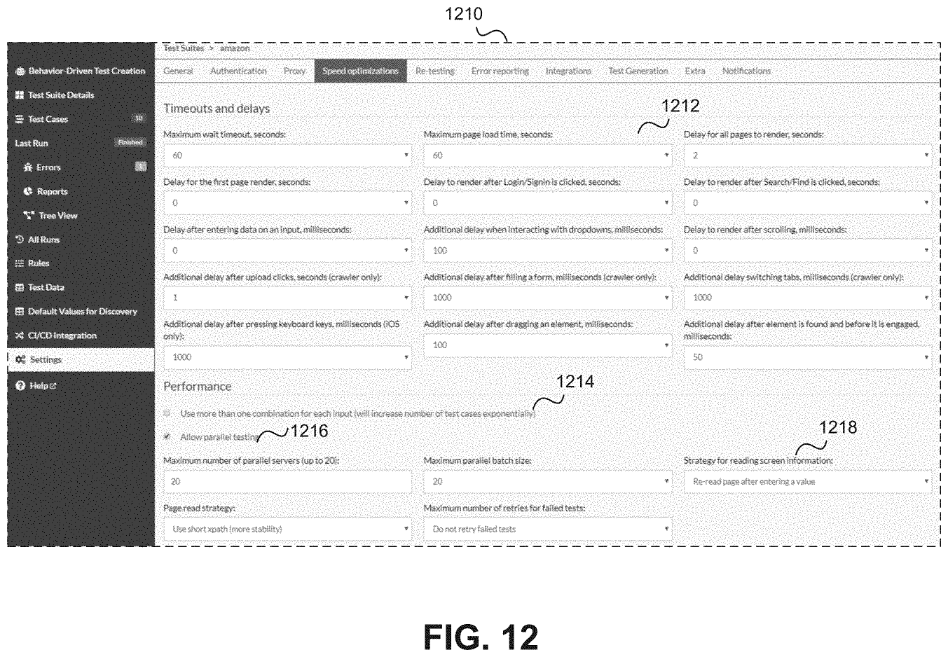

FIG. 12 shows another screen for configuring an automated test. Specifically, FIG. 12 shows a screen 1210 of an example developer GUI that includes various interactive elements through which a developer user 152 can set parameters to optimize the speed of performing an automated test. For example, screen 1201 includes various interactive elements 1212 (e.g., in the form of pull down menus) through which a developer user 152 can set values for various latency-related parameters such as maximum wait timeout, maximum page load time, and delay for page to render. Maximum wait timeout specifies how long the automated testing platform 120 will wait for a server to respond to a page request. Lower numbers will result in a faster test, but larger numbers will be more tolerant of a slow network and/or a busy server. Maximum page load time specifies how long the automated testing platform 120 will wait for a server to send a requested page. Again, lower numbers will result in a faster test, but larger numbers will be more tolerant of a slow network and/or a busy server. Delay for page to render specifies how long the automated testing platform 120 will wait for a given page to render. Lower numbers will result in a faster test, but larger numbers will be more tolerant of larger, more complex pages or pages that are rendered by JavaScript™ in the browser. These are just example latency-related parameters and as depicted in FIG. 12, the screen may include options to set values for other latency related parameters.

Screen 1210 also includes interactive elements through which a developer user 152 can specify how thoroughly the target application is explored during automated testing. For example, by selecting element 1214 (depicted as a toggle button), the developer user 152 can instruct the automated testing platform 120 to perform a more thorough automated test that involves performing more than one testing scenario for each input. As noted, this will tend to increase the number of testing scenarios exponentially, which will result in a more thorough test of the interactive features of the target application 132 although such a test will be slower and more computationally expensive. Other interactive elements may prompt the developer user 152 to, for example, enable the use of parallel testing of scenarios (button 1216) to reduce the time needed to complete testing. Other interactive elements may prompt the developer user 152 to, for example, specify a strategy for reading screen information (pull-down menu 1218). For example, pull-down menu 1218 is depicted as set to re-read a page after entering a value. This setting may slow down testing, but may catch issues that would otherwise be missed if a given page is not re-read after inputting a value. These are just some example configurable parameters that can be set by the developer user via the GUI to configure and automated test based on recorded user interaction with a target application.

Once the developer user 152 has finished configuring the various parameters associated with the automated testing process, an automated test is generated and performed on the target application 132. For example, as part of the automated testing process, one or more test executors 314 will crawl the target application 132 to discover and interact with various interactive elements (e.g., clicking buttons, clicking links, clicking pull-down menus, filling out forms, etc.) and will obtain results (e.g., screen captures) based on the testing.

In some embodiments, once the automated test is complete, a summary of the automated test is provided, for example, as depicted in screen 1310 of FIG. 13. As shown in FIG. 13, the summary of an example automated test may provide various aggregate test result data such as total number of test scenarios performed, total number of failed test scenarios, total number of discovered test scenarios, total number of unchanged test scenarios (e.g., between different versions of the target application 132), total number of disabled test scenarios, total number of test scenarios to be retested, and total time to perform the overall automated test. These are just some illustrative examples of the type of information that can be provided in a test summary. Other types of information can similarly be presented while remaining within the scope of the introduced technique.

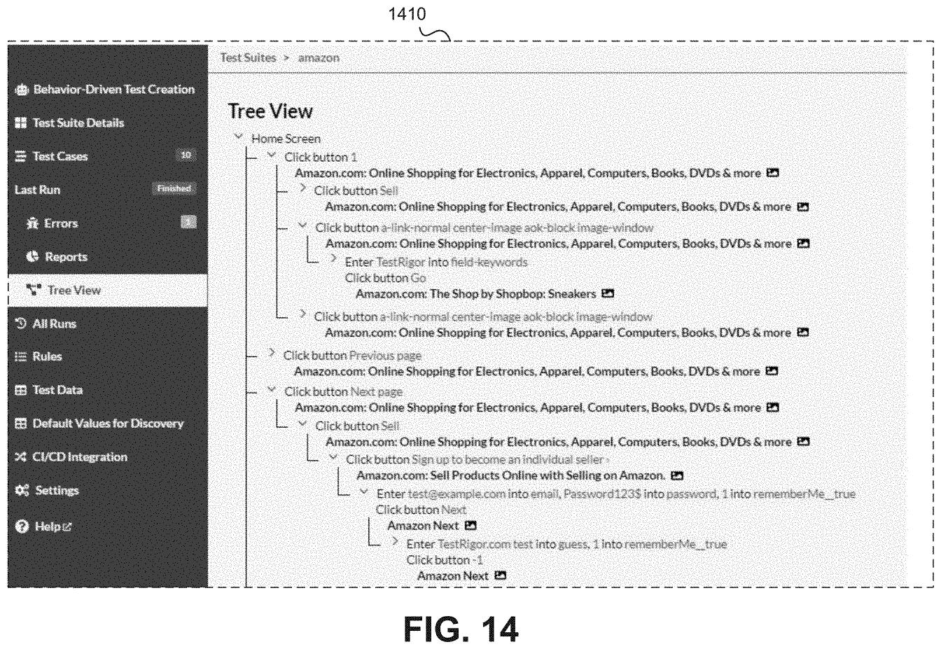

In some embodiments, tree view summary of the automated test can be displayed in the GUI. FIG. 14 shows a screen 1410 of an example developer GUI that includes a tree view summary of the various steps performed as part of an automated test. As shown in screen 1410, various steps performed by a test executor are listed (e.g., click button, enter value, etc.). The various steps are arranged as tree diagram based on branching interaction paths. For example, in the scenario depicted in screen 1410, each interaction path starts at a home screen of the target website and proceeds along different branches from that home screen. In some embodiments, the developer user can interact with the tree view summary to collapse and/or expand certain branches to facilitate navigation of the diagram.

In some embodiments, results of the automated test are presented in the developer GUI. FIG. 15 shows a screen 1510 of an example developer GUI that includes results from various test scenarios performed as part of an automated test of a target application (in this example a website). As shown in FIG. 15, screen 1510 includes interactive elements 1512a-c corresponding to various test scenarios performed as part of an automated test of a target website. The interactive elements 1512a-c include information regarding the corresponding test scenario such as a name of the test scenario, the steps involved in the test scenario (e.g., press button, enter value, etc.), a date the test scenario was created, a status of the test scenario, and duration of the test scenario.

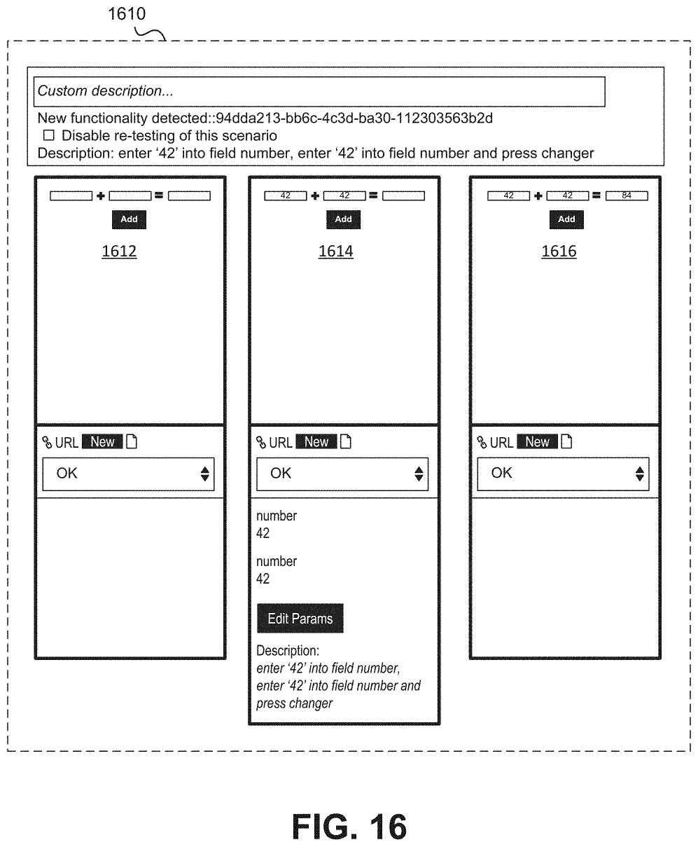

The interactive elements 1512a-c can be expanded to display results associated with each test scenario. For example, in response to detecting a user interaction, interactive element 1512c may dynamically expand to display results of the test scenario in the form of screen captures 1514 of the target application taken by the test executor during the various steps associated with the test scenario, as depicted in FIG. 15. Additional details on how test results can be presented in a developer GUI are described with respect to FIGS. 16-19.

FIG. 16 shows a screen 1610 of an example developer GUI that includes a sequence of screen captures depicting an example test scenario performed during the automated test of a target application 132 (in this case a calculator app). The sequence of screen captures depicted in screen 1610 may be similar to the sequence of screen captures 1514 depicted in screen 1510. Specifically, screen 1610 depicts a sequence of screenshots of the target application 132 during a test of a specific functionality an end user 142 may take while interacting with the target application 132. In this case, the interaction is entering a number into an editable field and pressing an “add” button. Screen capture 1612 shows the GUI of the target application 132 in a first state prior to entering the number, screen capture 1614 shows the GUI of the target application 132 in a second state after entering the number (“42”) but prior to pressing the “add” button, and screen capture 1616 shows the GUI of the target application 132 in a third state after pressing the “add” button. The example test scenario illustrated in the sequence of screen captures shown in FIG. 16 is relatively simple and is provided for illustrative purposes. An actual application may have many possible test scenarios involving more complicated sequences of interaction.

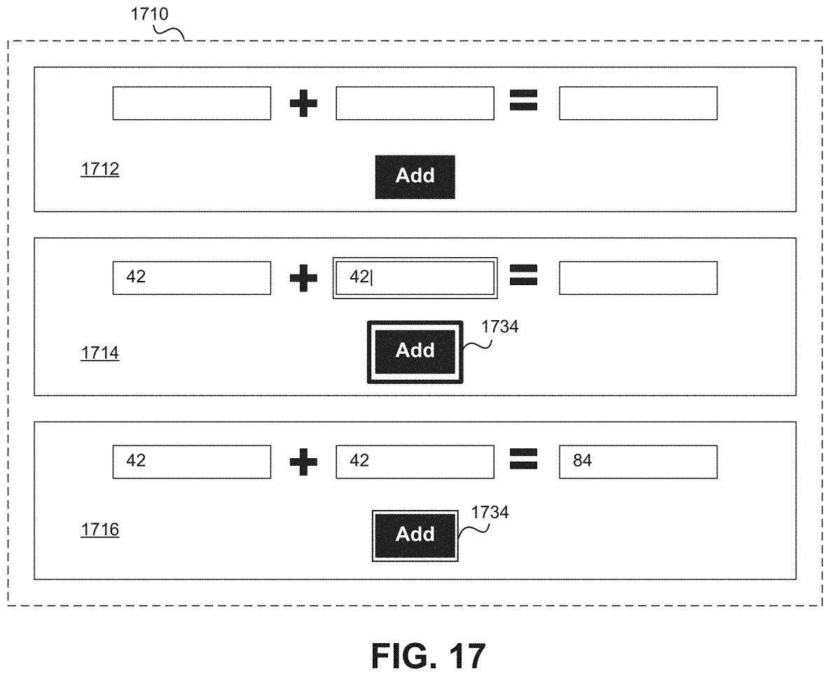

In some embodiments, the developer GUI may enable the developer user 152 to zoom in on the screen captures to view how the GUI of the target application 132 responded to various interactions. FIG. 17 shows an example screen 1710 of the developer GUI that shows a zoomed in portion of each of the respective screen captures 1612, 1614, and 1616 of FIG. 16. Specifically, screen capture 1712 shows a zoomed in portion of screen capture 1612 depicting the GUI of the target application 132 in the first state (i.e., before any interaction). Screen capture 1714 shows a zoomed in portion of screen capture 1614 depicting the GUI of the target application 132 in the second state (i.e., after entering the number 42 but before pressing the “add” button). Screen capture 1716 shows a zoomed in portion of screen capture 1616 depicting the GUI of the target application 132 in the third state (i.e., after pressing the “add” button).

In some embodiments, the screen captures displayed via the developer GUI may include visual augmentations that provide additional information to the developer user 152 reviewing the results. For example, as shown in FIG. 17, a visual augmentation 1734 is added to indicate the interaction leading to the next screen capture. Specifically, the visual augmentation 1734 includes a highlight that surrounds a region of the GUI of the target application 132 corresponding to the “add” button. This visual augmentation 1734 indicates to the developer user 152 that the “add” button is pressed resulting in the next screen capture 1716. This is just an example of a visual augmentation that can be added to screen captures to provide additional contextual information. Other types of visual augmentation can similarly be implemented. In some embodiments, the added visual augmentation can be color coded to indicate different types of interaction (e.g., button press vs. data entry). In some embodiments, visual augmentations may be animated to indicate different types of interaction (e.g., a gradually widening highlight indicating a button press).

As previously discussed, automated tests can be performed again, for example, after updating the target application 132 to a newer version. FIG. 18 includes a screen 1810 showing an updated test summary for the target application 132 resulting from a retest. In this case, the retest has resulted in several failed scenarios due, for example, to a change in the target application 132. In this example, the test summary indicates that 23% of the testing scenarios resulted in a failure.

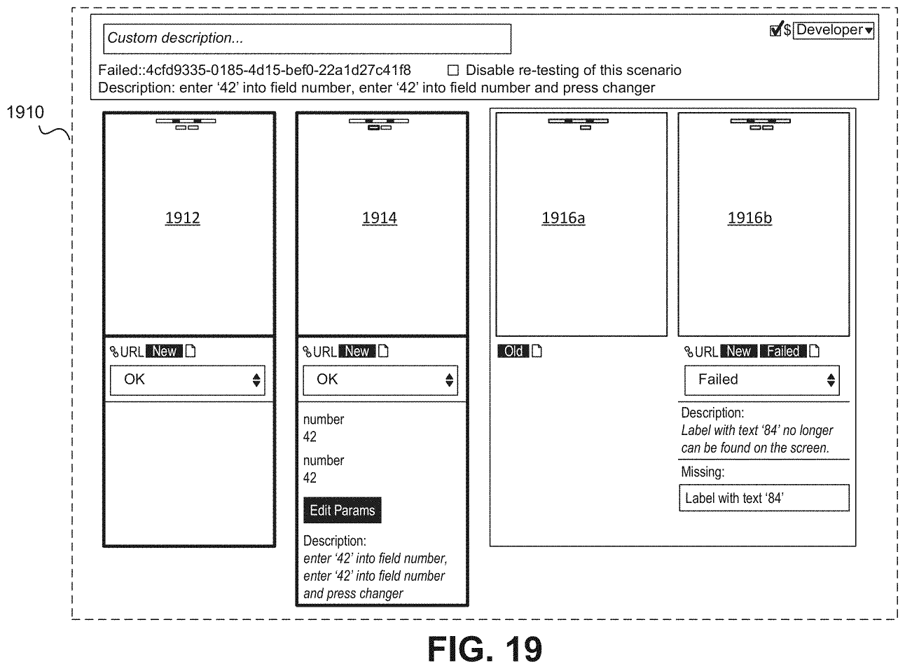

FIG. 19 includes a screen 1910 showing screen captures from the retest. As shown in FIG. 19, screen 1910 includes four total screen captures. Screen captures 1912 and 1914 are similar to screen captures 1612 and 1614 (respectively) of FIG. 16. However, screen 1910 also includes a pair of screen captures 1916a and 1916b that indicate a problem. Here, screen captures 1916a and 1916b represent a comparison between a screen capture from the initial test and a screen capture from the retest. In other words, screen capture 1916a is the same as screen capture 1616 (from FIG. 16) and screen capture 1916b shows a different state of the GUI of the target application 132 following the retest indicating that something in the test scenario is behaving differently. A developer user may review the comparison and determine, for example with the assistance of one or more visual augmentations, that the “add” button is no longer operating as expected. For example, a message is provided below screen capture 1914b indicating that the number “84” is no longer present in the screen even though it appeared in a corresponding screen during the initial test (see e.g., zoomed screen capture 1716).

What is claimed is:

1. A method comprising:
monitoring, by a computer system, end user interaction with a target application in a production environment;
generating, by the computer system, user interaction data based on the monitoring;
analyzing, by the computer system, user interaction with the target application by processing the user interaction data; and
generating, by the computer system, an automated test of the target application based on the analysis of the user interaction with the target application.

2. The method of claim 1, further comprising:
executing, by the computer system, the automated test of the target application.

3. The method of claim 2, wherein automated test of the target application is executed in a test environment that is different than the production environment.

4. The method of claim 2, further comprising:
generating, by the computer system, results based on the execution of the automated test; and
causing display, by the computer system, of the results at a computing device associated with a developer of the target application.

5. The method of claim 4, wherein generating the results based on the execution of the automated test of the target application includes:
capturing, by the computer system, one or more screen captures of a graphical user interface (GUI) of the target application, the one or more screen captures depicting one or more states of the GUI of the target application in response to interaction with one or more elements of the GUI of the target application.

6. The method of claim 1, wherein monitoring the end user interaction with the target application includes:
receiving, by the computer system, communications from a recorder library running in the target application, the communications indicative of one or more user interaction events detected by the recorder library.

7. The method of claim 6, wherein generating the user interaction data includes:
grouping, by the computer system, the detected user interaction events based on identified user sessions.

8. The method of claim 1, wherein analyzing the user interaction with the target application includes processing the user interaction data to discover patterns in the user interaction with the target application.

9. The method of claim 1, wherein the user interaction data is organized based on identified user sessions, each of the identified user sessions including a sequence of time-stamped user interaction events, wherein processing the user interaction data includes:
grouping each of the identified user sessions into one of a plurality of discovered user interaction patterns based on the sequence of time-stamped user interaction events included in the respective identified user sessions.

10. The method of claim 1, wherein generating the automated test of the target application includes:
generating a testing scenario that corresponds with a user interaction pattern discovered based on the processing of the user interaction data, the testing scenario defining a sequence of steps of interaction with one or more interactive elements of a GUI of the target application.

11. The method of claim 10, generating the automated test of the target application further includes:
determining that the discovered user interaction pattern satisfies a testing criterion;
wherein the testing scenario is generated in response to determining that the user interaction pattern satisfies the testing criterion.

12. The method of claim 11, wherein the testing criterion specifies a threshold associated with the user interaction pattern, the threshold based on any of:
a total number of user interactions with the target application that match the user interaction pattern;
a frequency of user interactions with the target application that match the user interaction pattern; or
a percentage of all user interactions with the target application that match the user interaction pattern.

13. The method of claim 10, wherein generating the automated test of the target application further includes:
prioritizing the testing scenario corresponding with the user interaction pattern.

14. The method of claim 13, wherein prioritizing the testing scenario includes any of:
designating that the testing scenario is to be performed before performing a different testing scenario when executing the automated test;
designating computing resources to be allocated to performing the testing scenario over performing the different testing scenario when executing the automated test; or
designating that the testing scenario is to be performed more frequently than a different testing scenario when executing the automated test.

15. The method of claim 10, wherein the one or more interactive elements of the GUI include any of a button, an editable field, or a pull-down menu.

16. A computer system comprising:
a processor; and
a memory coupled to the processor, the memory having instructions stored thereon, which when executed by the processor, cause the computer system to:
monitor end user interaction with a target application in a production environment;
generate user interaction data based on the monitoring;
analyze user interaction with the target application by processing the user interaction data; and
generate an automated test of the target application based on the analysis of the user interaction with the target application.

17. The computer system of claim 16, wherein the memory has further instructions stored thereon, which when executed by the processor, cause the computer system to further:
execute the automated test of the target application in a test environment that is different than the production environment;
generate results based on the execution of the automated test; and
cause display of the results at a computing device associated with a developer of the target application.

18. The computer system of claim 16, wherein analyzing the user interaction with the target application includes processing the user interaction data to discover a user interaction pattern.

19. The computer system of claim 18, wherein generating the automated test of the target application includes:
generating a testing scenario that corresponds with the discovered user interaction pattern, the testing scenario defining a sequence of steps of interaction with one or more interactive elements of a GUI of the target application.

20. A non-transitory computer-readable medium containing instructions, execution of which in a computer system causes the computer system to:
monitor end user interaction with a target application in a production environment;
generate user interaction data based on the monitoring;
analyze user interaction with the target application by processing the user interaction data; and
generate an automated test of the target application based on the analysis of the user interaction with the target application.

21. The non-transitory computer-readable medium of claim 20, containing further instructions, execution of which in the computer system causes the computer system to further:
execute the automated test of the target application in a test environment that is different than the production environment;
generate results based on the execution of the automated test; and
cause display of the results at a computing device associated with a developer of the target application.

22. The non-transitory computer-readable medium of claim 20, wherein analyzing the user interaction with the target application includes processing the user interaction data to discover a user interaction pattern.

23. The non-transitory computer-readable medium of claim 20, wherein generating the automated test of the target application includes:
generating a testing scenario that corresponds with the discovered user interaction pattern, the testing scenario defining a sequence of steps of interaction with one or more interactive elements of a GUI of the target application.
